(19) United States
(12) Patent Application Publication
(10) Pub. No.: US 2021/0150453 A1
(43) Pub. Date: May 20, 2021

(54) CANDIDATE TEAM RECOMMENDATIONS

(71) Applicant: Microsoft Technology Licensing, LLC, Redmond, WA (US)

(72) Inventors: Cagri Ozcaglar, Sunnyvale, CA (US); Krishnaram Kenthapadi, Sunnyvale, CA (US)

(73) Assignee: Microsoft Technology Licensing, LLC, Redmond, WA (US)

(21) Appl. No.: 16/685,725

(22) Filed: Nov. 15, 2019

(51) Int. Cl. G06Q 10/06

(52) U.S. Cl. CPC G06Q 10/063118; G06Q 10/0633; G06Q 10/063112

(57) ABSTRACT

The disclosed embodiments provide a system for processing data. During operation, the system obtains, based on parameters of a search of an online system by a user, counts of attributes required by a set of opportunities within a team. Next, the system determines, based on data retrieved from a data store, multiple sets of candidates for the set of opportunities based on multiple objectives that comprise maximizing coverage of the counts of attributes by a given set of candidates. The system then selects, from the multiple sets of candidates, one or more sets of candidates that best meet one or more combinations of the multiple objectives. Finally, the system outputs, in a user interface of the online system, the one or more sets of candidates as recommendations for filling the set of opportunities in the team.

### BACKGROUND

### Field

The disclosed embodiments relate to user recommendations. More specifically, the disclosed embodiments relate to techniques for generating candidate team recommendations.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating a process of determining the multiple sets of candidates for the set of opportunities based on multiple objectives in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for ranking candidate search results. For example, the rankings include rankings of candidates for jobs, positions, roles, and/or other opportunities. The rankings also, or instead, include rankings or recommendations of connections, follows, mentorships, referrals, online dating matches, and/or other types of relationships or interactions for members of an online network. Each ranking can be produced by ordering the candidates by descending score from one or more machine learning models and/or formulas. As a result, candidates at or near the top of a ranking may be deemed to be better qualified for the corresponding opportunity and/or recommendation than candidates that are lower in the ranking.

More specifically, the disclosed embodiments provide a method, apparatus, and system for generating rankings and/or recommendations of teams of candidates. In these embodiments, a recruiter (or another entity) identifies or specifies a set of opportunities that represent some or all of a team (e.g., within the same project, organization, or company). Each opportunity includes a set of requirements, such as skills, work experience, titles, industries, education, and/or other attributes to be possessed by candidates for the opportunity. In turn, teams of candidates that meet all requirements in the set of opportunities and satisfy other constraints or objectives associated with formation of the teams are created and outputted as recommendations within an online system to the recruiter.

In one or more embodiments, objectives associated with generating and/or selecting teams of candidates include a team size objective, a coverage objective, a connectivity objective, and/or a diversity objective. The team size objective and coverage objective are used to minimize the number of candidates that meet the collective requirements of the set of opportunities. The connectivity objective minimizes the average shortest-path distance between pairs of members in the team, and the diversity objective reduces the amount of skew in the proportions of one or more attributes in the team, when compared with a corresponding pool of candidates from which members of the team are selected.

The objectives can be represented using a multi-objective optimization problem, which is solved by forming teams of candidates that best meet a given combination or ordering of the objectives. For example, the first candidate in each team is selected to have the greatest coverage of requirements of the opportunities (e.g., by possessing the largest number of attributes required by the set of opportunities). Subsequent candidates are added to the team in a way that optimizes for all of the objectives. Adding of candidates to the team is discontinued after one or more of the objectives are met (e.g., counts of required attributes in the opportunities are found in the team), the addition of candidates to the team does not further optimize any of the objectives, and/or no additional candidates are available to be added to the set.

Finally, some or all of the teams are outputted as recommendations to the recruiter. For example, the teams are ordered by ascending number of candidates, descending coverage of requirements in the set of opportunities, and/or ascending total “rank” associated with the objectives and/or constraints, and some or all of the ranking is displayed or transmitted to the recruiter to assist the recruiter with placement of the opportunities.

By generating and recommending sets of candidates that meet the collective requirements of multiple opportunities within a team, the disclosed embodiments allow recruiters (or other entities) to perform hiring or placement related to the opportunities in a way that improves the overall composition of the team and/or priorities or objectives associated with forming the team. The recruiters are also able to find qualified candidates for multiple opportunities within the same set of search results or recommendations, which reduces the amount of searching and/or browsing performed by the recruiters to place the jobs. The reduction in processing associated with the recruiters' searches and/or views additionally improves the utilization of processor, memory, storage, input/output (I/O), and/or other resources by the online system and/or the performance of applications, services, tools, and/or computer systems used to implement the online system. Consequently, the disclosed embodiments may improve computer systems, applications, user experiences, tools, and/or technologies related to generating recommendations, employment, recruiting, and/or hiring.

### Candidate Team Recommendations

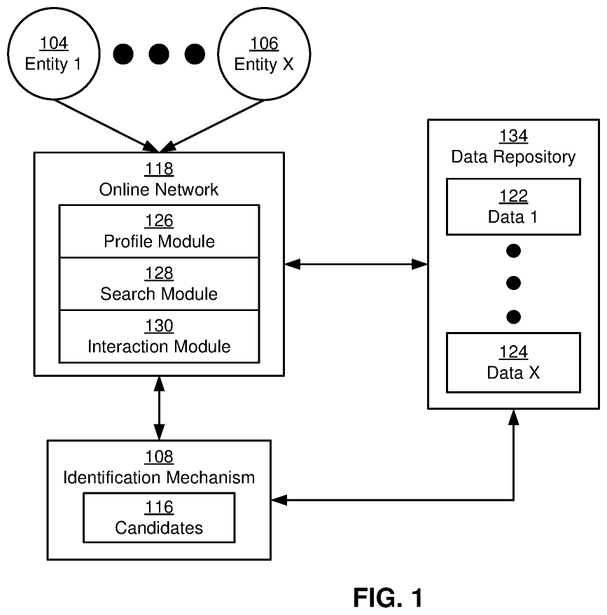

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 may be inputted into the machine learning model(s), along with features and/or characteristics of the corresponding opportunities (e.g., required or desired skills, education, experience, industry, title, etc.). In turn, the machine learning model(s) may output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and descriptions of the opportunities. The model(s) optionally adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores and/or associated insights improve the quality of candidates 116, recommendations of opportunities to candidates 116, and/or recommendations of candidates 116 for opportunities. Such rankings also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

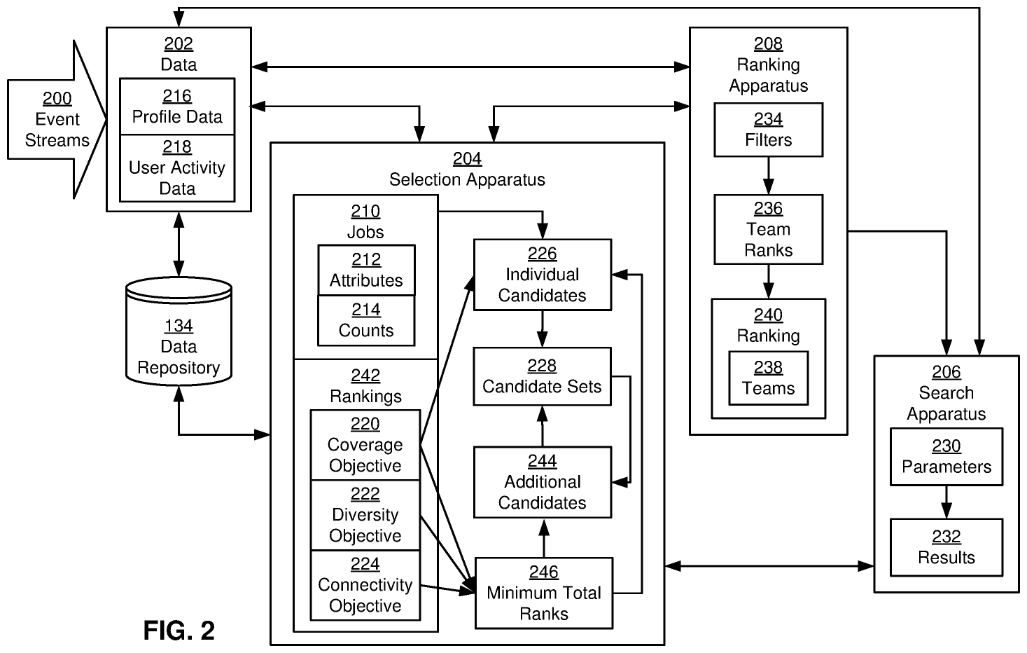

In one or more embodiments, online network 118 includes functionality to improve rankings of candidates 116 outputted as recommendations to recruiters by recommending sets of candidates that can be used to fill multiple positions or openings within a team. As show in FIG. 2, data 202 from data repository 134 is used to generate a ranking 240 of teams 238 of candidates in response to parameters 230 of a search by a recruiter and/or another moderator of opportunities. Data 202 includes profile data 216 for members of an online platform (e.g., online network 118 of FIG. 1), as well as user activity data 218 that tracks the members' and/or candidates' activity within and/or outside the platform.

Profile data 216 includes data associated with member profiles in the platform. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, awards or honors earned by the user, licenses or certifications attained by the user, patents or publications associated with the user, and/or other data related to the user's interaction with the platform.

Attributes of the members are optionally matched to a number of member segments, with each member segment containing a group of members that share one or more common attributes. For example, member segments in the platform may be defined to include members with the same industry, title, location, and/or language.

Connection information in profile data 216 is optionally combined into a graph, with nodes in the graph representing entities (e.g., users, schools, companies, locations, etc.) in the platform. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

User activity data 218 includes records of user interactions with one another and/or content associated with the platform. For example, user activity data 218 tracks impressions, clicks, likes, dislikes, shares, hides, comments, posts, updates, conversions, and/or other user interaction with content in the platform. User activity data 218 also, or instead, tracks other types of activity, including connections, messages, job applications, job searches, recruiter searches for candidates, interaction between candidates 116 and recruiters, and/or interaction with groups or events. In some embodiments, user activity data 218 further includes social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 additionally includes schedules, calendars, and/or upcoming availabilities of the users, which may be used to schedule meetings, interviews, and/or events for the users. Like profile data 216, user activity data 218 is optionally used to create a graph, with nodes in the graph representing members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

In one or more embodiments, profile data 216, user activity data 218, and/or other data 202 in data repository 134 is standardized before the data is used by components of the system. For example, skills in profile data 216 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, user activity data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform. One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

A search apparatus 206 uses data 202 in data repository 134 to identify candidates (e.g., candidates 116 of FIG. 1) that match parameters 230 of a search. For example, search apparatus 206 is provided by a recruiting module or tool that is associated with and/or provided by the platform. Search apparatus 206 includes checkboxes, radio buttons, drop-down menus, text boxes, and/or other user-interface elements that allow a recruiter and/or another moderator involved in hiring for or placing jobs or opportunities to specify parameters 230 related to candidates for an opportunity and/or a number of related opportunities.

In some embodiments, parameters 230 identify and/or describe a set of jobs 210 (or other opportunities) that represent some or all of a team within a project, company, organization, and/or another grouping of jobs 210. For example, parameters 230 include thresholds, values, and/or ranges of values for an industry, location, education, skills, past positions, current positions, seniority, overall qualifications, title, seniority, keywords, awards, publications, patents, licenses and certifications, and/or other attributes 212 of candidates for jobs 210. A recruiter involved in hiring for jobs 210 specifies parameters 230 as lists of required attributes 212 for individual jobs 210. In turn, search apparatus 206 combines the lists into counts 214 of required attributes 212 collectively required by the set of jobs 210.

Parameters 230 also, or instead, include identifiers (IDs) for jobs 210 in data repository 134 and/or text or documents containing descriptions and/or requirements for jobs 210. After the recruiter submits parameters 230, search apparatus 206 analyzes the content of jobs 210 and extracts additional parameters 230 that include a set of attributes 212 listed as requirements of jobs 210. Search apparatus 206 then aggregates the requirements into counts 214 of attributes 212 collectively required by jobs 210.

In some embodiments, search apparatus 206 matches or converts some or all parameters 230 to standardized attributes in data repository 202. For example, search apparatus 206 converts a misspelled, abbreviated, and/or non-standardized company name, title, location, skill, seniority, and/or other word or phrase in parameters 230 into a standardized identifier or value for a corresponding attribute. Search apparatus 206 also, or instead, adds standardized titles, skills, companies, and/or other attributes that are similar to those specified in parameters 230 to an updated set of parameters 230.

Search apparatus 206 and/or another component then queries data repository 134 for candidates with profile data 216 that matches some or all parameters 230. In response to the query, data repository 134 returns member identifiers and/or profile data 216 of the matching candidates. For example, data repository 134 identifies thousands to tens of thousands of candidates with profile attributes that meet or fit some or all required attributes 212 of one or more jobs 210 and returns some or all of the candidates in a response to the query. The returned candidates thus represent a “pool” of candidates from which teams 238 of candidates for the set of jobs 210 can be formed.

A selection apparatus 204 generates teams 238 representing candidate sets 228 composed of multiple candidates that can be used to fill jobs 210. As shown in FIG. 2, candidate sets 228 are generated based on counts 214 of attributes 212 required by jobs 210 and a number of objectives, which include a coverage objective 220, a diversity objective 222, and a connectivity objective 224.

Coverage objective 220 includes minimizing the number of candidates in a team while maximizing the coverage of counts 214 of attributes 212 required by jobs 210. For example, coverage objective 220 includes the following representation:

$$min \vert {C}^{*} \vert$$

$$max \frac{{{\sum }_{i = 1}}^{n} min ( {c}_{i}^{t} , {\sum }_{c ∈ {C}^{*}} δ ( c , {s}_{i}^{t} ) )}{{{\sum }_{i = 1}}^{n} {c}_{i}^{t}}$$

$$s . t . {C}^{*} ∈ C$$

In the above representation, C represents the pool of candidates from which a team t composed of candidates C* is selected, sᵢ^{t} represents the ith skill (or another attribute) required by the set of jobs 210 (where i∈{1, n}), and cᵢ^{t} represents the count of the skill as a requirement in jobs 210. In addition, δ(c, s) is a binary indicator that represents whether or not candidate c has skill s. As a result, coverage objective 220 seeks to find the minimum number of candidates in the team that possess all counts 214 of attributes 212 required by jobs 210.

Diversity objective 222 includes minimizing deviation of candidates in the team from a distribution of one or more demographic attributes in the candidate pool. For example, diversity objective 222 includes the following representation:

$$S k e {w}_{{a}_{i}} ( {C}^{*} ) = log ( \frac{p ( {C}^{*} , {a}_{i} )}{p ( C , {a}_{i} )} )$$

$$Min Ske w ( {C}^{*} ) = {min}_{{a}_{i} ∈ A} S k e {w}_{{a}_{i}} ( {C}^{*} )$$

$$M a x S k e w ( {C}^{*} ) = {max}_{{a}_{i} ∈ A} S k e {w}_{{a}_{i}} ( {C}^{*} )$$

$$max MinSkew ( {C}^{*} ) , min MaxSkew ( {C}^{*} )$$

In the above representation, A represents a demographic attribute (e.g., gender, age range, ethnicity, etc.), aᵢ represents the ith value of the attribute, p(C,aᵢ) represents the proportion of candidates in the candidate pool with the attribute value, and p(C*,aᵢ) represents the proportion of candidates in the team with the attribute value. A skew metric for aᵢ in the team of candidates C* is calculated as a logarithm of the proportion of candidates in the team with the attribute value divided by the proportion of candidates in the candidate pool with the attribute value. A negative value of the skew metric represents a lower representation of candidates with the attribute value in the team (when compared with the candidate pool), and a positive value of the skew metric represents a higher representation of candidates with the attribute value in the team (when compared with the candidate pool).

Continuing with the above example, the skew metric may utilize the logarithm to allow skew on either side to be symmetric with respect to the ratio of the two proportions. For example, a ratio of 0.5 or 2 between the proportion of candidates with the attribute value in the team and the corresponding proportion of candidates with the attribute value in candidate pool may result in the same magnitude and opposite signs in the skew metric. Moreover, a skew in one direction for a given value of the attribute (e.g., a female gender) results in a skew in the opposite direction for a different value of the attribute (e.g., a male gender). Consequently, diversity objective 222 includes minimizing the maximum skew (which is always greater than or equal to zero) and maximizing the minimum skew (which is always less than or equal to zero) across all values of each attribute under consideration.

Connectivity objective 224 includes minimizing the network distance of candidates within the team (e.g., within online network 118 or another type of social network). For example, connectivity objective 224 includes the following representation:

$$min \frac{{\sum }_{1 \leq i \leq j \leq \vert {C}^{*} \vert ; {c}_{i} , {c}_{j} ∈ {C}^{*}}^{n} d ( {c}_{i} , {c}_{j} )}{C ( \vert {C}^{*} \vert , 2 )}$$

In the above representation, d(cᵢ, cⱼ) represents the shortest-path distance between candidates c and c₁, based on a graph of connections in the social network, and C(i, j) represents the number of j-combinations of a set with i elements. As a result, connectivity objective 224 is used to minimize the average distance between all pairs of candidates in the team, which in turn increases connectivity of the candidates within the team.

Coverage objective 220, diversity objective 222, and connectivity objective 224 can be formulated into a multi-objective optimization problem that is used to form teams 238 of candidates for jobs 210. For example, the above representations of coverage objective 220, diversity objective 222, and connectivity objective 224 can be combined into the following multi-objective minimization problem:

$$\begin{matrix}min \vert {C}^{*} \vert , & ( 1 ) \\ - \frac{{{\sum }_{i = 1}}^{n} min ( {c}_{i}^{t} , {\sum }_{c ∈ {C}^{*}} δ ( c , {s}_{i}^{t} ) )}{{{\sum }_{i = 1}}^{n} {c}_{i}^{t}} , & ( 2 ) \\ MaxSke w ( {C}^{*} ) - M i n S k e w ( {C}^{*} ) , & ( 3 ) \\ \frac{{\sum }_{1 \leq i \leq j \leq \vert {C}^{*} \vert ; {c}_{i} , {c}_{j} ∈ {C}^{*}}^{n} d ( {c}_{i} , {c}_{j} )}{C ( \vert {C}^{*} \vert , 2 )} , s . t . {C}^{*} ∈ C & ( 4 )\end{matrix}$$

In the multi-objective minimization problem, Equation 2 represents an objective function for coverage objective 220, Equation 3 represents an objective function for diversity objective 222, and Equation 4 represents an objective function for connectivity objective 224. Equation 1 represents an objective function for an additional (optional) objective for minimizing the number of candidates in teams 238.

In one or more embodiments, selection apparatus 204 generates candidate sets 228 over a series of steps that iteratively optimize for different objectives in the above multi-objective optimization problem. First, selection apparatus 204 performs an initialization step that identifies individual candidates 226 in the candidate pool that optimize coverage objective 220.

For example, selection apparatus 204 iterates over the pool of candidates and uses Equation 2 above to calculate the proportional coverage of attributes 212 required by the set of jobs 210 for each candidate (e.g., if the candidate possesses three of five required attributes 212, each of which has a count of 3 in jobs 210, the candidate has a proportional coverage of 3/(5*3), or 0.2). At each iteration, selection apparatus 204 compares the proportional coverage of attributes 212 for the current candidate with the maximum proportional coverage of attributes 212 found in candidates from previous iterations. If the current candidate's proportional coverage of attributes 212 is higher than the maximum proportional coverage encountered in all previous candidates, the maximum proportional coverage is set to the current candidate's proportional coverage of attributes 212, and a set of individual candidates 226 with maximum proportional coverage is initialized with the candidate. If the current candidate's proportional coverage of attributes 212 is equal to the maximum proportional coverage encountered in all previous candidates, the candidate is added to the set of individual candidates 226 with maximum proportional coverage. Thus, the initialization step generates a set of individual candidates 226, with all candidates in the set sharing the highest proportional coverage of attributes 212 required by jobs 210.

After the initialization step is complete, selection apparatus 204 performs an update step that initializes multiple candidate sets 228 with individual candidates 226 and adds additional candidates 224 to candidate sets 228 according to coverage objective 220, diversity objective 222, and connectivity objective 224. The update step begins with creating candidate sets 228 as one-element sets containing different individual candidates 226 with the highest proportional coverage of attributes 212 identified in the initialization step. For example, the update step begins by separating 10 individual candidates 226 with the highest proportional coverage of attributes 212 in jobs 210 into 10 candidate sets 228 with one candidate in each set.

Next, the update step iterates over candidate sets 228; for each candidate set, selection apparatus 204 generates rankings 242 of remaining candidates from the candidate pool (i.e., candidates in the candidate pool that are not in the candidate set) by objective functions for the multiple objectives. For example, selection apparatus 204 uses Equation 2 to calculate a metric related to coverage objective 220, Equation 3 to calculate a metric related to diversity objective 222, and Equation 4 to calculate a metric related to connectivity objective 224 between each of the remaining candidates and the candidate set. Selection apparatus 204 then generates rankings 242 of the remaining candidates by ascending metric for each of the objectives. As a result, the highest-ranked candidates for a given metric are best at optimizing for the corresponding objective.

The update step then identifies one or more additional candidates 244 with minimum total ranks 246 from a combination of rankings 242 and adds additional candidates 244 to the candidate set. For example, selection apparatus 204 iterates over all remaining candidates in the candidate pool for the candidate set. At each iteration, selection apparatus 204 calculates a “total rank” for a candidate as the sum of the candidate's numeric ranks in rankings 242. Selection apparatus 204 also compares the candidate's total rank to the minimum total rank found in candidates from previous iterations. If the current candidate's total rank is lower than the minimum total rank encountered in all previous candidates, the minimum total rank is set to the current candidate's total rank, and a set of additional candidates 244 with the minimum total rank is initialized with the candidate. If the current candidate's total rank is equal to the minimum total rank encountered in all previous candidates, the candidate is added to the set of additional candidates 244 with the minimum total rank. After total ranks of all remaining candidates have been calculated and used to identify one or more additional candidates 244 with a minimum total rank across rankings 242, selection apparatus 204 adds additional candidates 244 to the candidate set.

After a given set of additional candidates 244 with minimum total rank is added to a corresponding candidate set, selection apparatus 204 updates rankings 242 of remaining candidates not in the candidate set to reflect the newly added candidates to candidate sets 228. For example, selection apparatus 204 recalculates metrics associated with the objective functions in Equations 2, 3, and 4 between each of the remaining candidates and the new candidate set and re-ranks the remaining candidates by the updated metrics. As a result, the updated metrics and rankings 242 reflect changes in attribute coverage, diversity, and connectivity between the remaining candidates and the candidate set. Selection apparatus 204 also determines new total ranks for the remaining candidates based on the updated rankings 242 and selects another batch of additional candidates 244 with a minimum total rank for inclusion in the candidate set.

Selection apparatus 204 continues updating rankings 242 of remaining candidates in the candidate pool to reflect changes to candidate sets 228 and identifying candidates with minimum total ranks 246 in the updated rankings 242 to add to candidate sets 228 until one or more objectives cannot be optimized further. For example, selection apparatus 204 iteratively adds additional candidates 244 with minimum total rank to a given candidate set until the candidate set fully satisfies coverage objective 220 (i.e., all counts 214 of attributes 214 required by jobs 210 are met by the candidate set) and/or the remaining candidates cannot be used to further optimize coverage objective 220 and/or other objectives.

After generation of candidate sets 228 is complete, a ranking apparatus 208 generates ranking 240 of some or all candidate sets 228 as teams 238 that can be hired to meet the requirements of jobs 210. First, ranking apparatus 208 applies one or more filters 234 to candidate sets 228. For example, ranking apparatus 208 de-duplicates identical candidate sets 228 generated by selection apparatus 204 by adding sorted candidates of each candidate set into a Trie data structure and marking the last element of each set as a leaf node of the data structure. When a given candidate set has a last element that falls on a pre-existing leaf node in the Trie (e.g., a leaf node that was added as the last element of another candidate set), the candidate set is identified as a duplicate of the other candidate set and omitted from candidate sets 228.

In another example, ranking apparatus 208 optionally enforces an objective or constraint for minimizing the number of candidates in teams 238 by selecting only candidate sets 228 with the minimum number of candidates for inclusion in ranking 240. Ranking apparatus 208 also, or instead, applies a variation of the objective or constraint by restricting candidate sets 228 to having numbers of candidates that are within a threshold from the minimum-size candidate set and/or the number of jobs 210 to be placed.

After filters 234 have been applied, ranking apparatus 208 generates ranking 240 by team ranks 236 representing combined numeric ranks of candidate sets 228 in rankings 242 by metrics associated with coverage objective 220, diversity objective 222, connectivity objective 224, and/or other objectives. For example, ranking apparatus 208 calculates values of Equations 2, 3, and 4 for each candidate set and generates a separate ranking of the candidate sets by ascending values for the corresponding objective. Ranking apparatus 208 then calculates a team rank for each candidate set as the sum of numeric ranks of the candidate set in the rankings for coverage objective 220, diversity objective 222, connectivity objective 224, and/or other objectives and generates ranking 240 of candidate sets 228 by ascending team rank.

Finally, search apparatus 206 outputs some or all of ranking 240 as search results 232 of the search. For example, search apparatus 206 displays a list of teams 238 ordered by ascending team rank. Each team includes a set of candidates that can be viewed by interacting with one or more user-interface elements (e.g., sliders, drop-down menus, sub-menus, etc.).

Search apparatus 206 and/or another component additionally include functionality to output multiple sets of search results 232 based on different rankings of teams 238. For example, search apparatus 206 may output, in response to parameters 230 of a search by a recruiter, a first set of search results 232 that includes a “default” ranking of teams 238 by team ranks 236. Search apparatus 206 may also provide one or more user-interface elements that allow the recruiter to filter and/or sort teams 238 in the search results 232 by number of candidates, diversity, connectivity, additional requirements not specified in jobs 210, and/or other criteria. As a result, the system of FIG. 2 may allow the recruiter to manipulate and/or reorder results 232, depending on the recruiter's preferences and/or objectives with respect to a given opportunity or set of opportunities.

By generating and recommending sets of candidates that meet the collective requirements of multiple opportunities within a team, the system of FIG. 2 allows recruiters (or other entities) to perform hiring or placement related to the opportunities in a way that improves the overall composition of the team and/or priorities or objectives associated with forming the team. The recruiters are also able to find qualified candidates for multiple opportunities within the same set of search results or recommendations, which reduces the amount of searching and/or browsing performed by the recruiters to place the jobs. The reduction in processing associated with the recruiters' searches and/or views additionally improves the utilization of processor, memory, storage, input/output (I/O), and/or other resources by the online system and/or the performance of applications, services, tools, and/or computer systems used to implement the online system. Consequently, the disclosed embodiments may improve computer systems, applications, user experiences, tools, and/or technologies related to generating recommendations, employment, recruiting, and/or hiring.

Those skilled in the art will appreciate that the system of FIG. 2 may be implemented in a variety of ways. First, selection apparatus 204, ranking apparatus 208, search apparatus 206, and/or data repository 134 may be provided by a single physical machine, multiple computer systems, one or more virtual machines, a grid, one or more databases, one or more filesystems, and/or a cloud computing system. Selection apparatus 204, ranking apparatus 208, and search apparatus 206 may additionally be implemented together and/or separately by one or more hardware and/or software components and/or layers.

Second, a number of techniques may be used to generate individual candidates 226, candidate sets 228, teams 238, ranking 240, and/or results 232. For example, candidate sets 228 and/or teams 238 may be generated and/or selected to optimize for additional objectives and/or a different set of objectives (e.g., objectives related to location, language, background, experience, roles, etc.). In another example, candidate sets 228, teams 238, and/or ranking 240 are generated based on the recruiter's preferences or priorities with respect to the objectives and/or other attributes of the candidates. In a third example, total ranks used to select candidates for inclusion in candidate sets 228 and/or team ranks 236 used to generate ranking 240 are calculated based on weighted combinations of numeric ranks in the corresponding rankings (e.g., to allow certain objectives to be prioritized over others in the generation and ranking of candidate sets 228). In a fourth example, selection apparatus 204 uses a scalarization technique, a posteriori method, interactive method, hybrid method, and/or another technique for solving multi-objective optimization problems to generate and rank candidate sets 228.

Third, the system of FIG. 2 may be adapted to generate search results 232 or recommendations for various types of searches and/or entities. For example, the functionality of the system may be used to recommend teams of candidates for research labs, artistic or musical groups, classes, projects, travel groups, events, and/or other types of opportunities or endeavors.

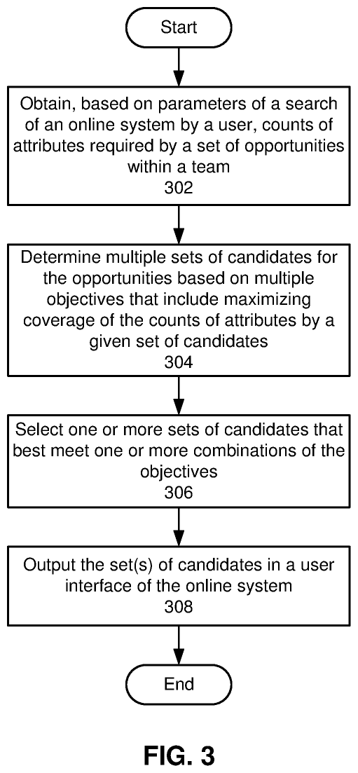

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, counts of attributes required by a set of opportunities within a team are obtained based on parameters of a search of an online system by a user (operation 302). For example, the user includes a recruiter that identifies a set of jobs. In turn, the counts of attributes are obtained by aggregating requirements from descriptions of the jobs. In another example, the user specifies a list of requirements for each job and/or aggregated counts of the required attributes for the set of jobs.

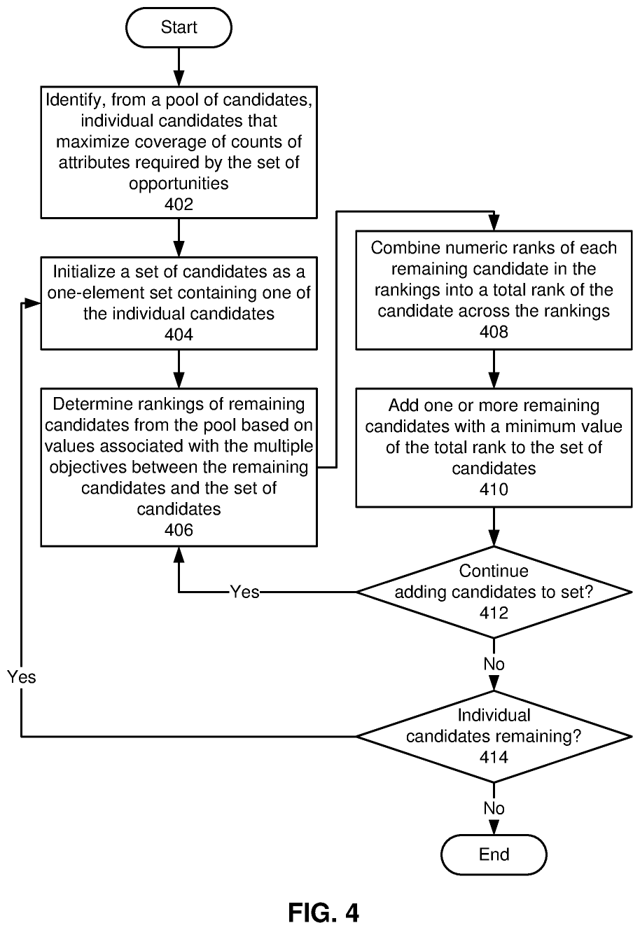

Next, multiple sets of candidates for the opportunities are determined based on multiple objectives that include maximizing coverage of the counts of attributes by a given set of candidates (operation 304), as described in further detail below with respect to FIG. 4. One or more sets of candidates that best meet one or more combinations of the objectives are then selected (operation 306). For example, rankings of the multiple sets of candidates by the objectives are generated, and numeric ranks of each set of candidates in the rankings are summed into a team rank for the set of candidates. The sets of candidates are ordered by the team rank into an aggregate ranking, and at least a portion of the aggregate ranking is included in the selected set(s) of candidates. In another example, duplicate sets of candidates are removed from the multiple sets of candidates and/or the set(s) of candidates are selected to have the smallest number of candidates.

Finally, the set(s) of candidates are outputted in a user interface of the online system (operation 308). For example, some or all of the aggregate ranking is displayed in one or more pages of search results to the user. Each search result includes a list of candidates that make up the corresponding team (or portion of the team).

FIG. 4 shows a flowchart illustrating a process of determining the multiple sets of candidates for the set of opportunities based on multiple objectives in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, individual candidates that maximize coverage of counts of attributes required by the set of opportunities are identified from a pool of candidates (operation 402). For example, each of the individual candidates is identified to have the most number of distinct skills (or other attributes) required by a set of jobs.

Next, a set of candidates is initialized as a one-element set containing one of the individual candidates (operation 404), and rankings of remaining candidates from the pool are determined based on values associated with the multiple objectives between the remaining candidates and the set of candidates (operation 406). For example, the rankings include a first ranking of the remaining candidates by a skew from a distribution of one or more attributes (e.g., gender, age range, ethnicity, etc.) in the pool of candidates, a second ranking of the remaining candidates by an average connectivity with the set of candidates, and/or a third ranking of the remaining candidates by coverage of the counts of attributes required by the set of opportunities.

Numeric ranks of each remaining candidate in the rankings are then combined into a total rank of the candidate across the rankings (operation 408), and one or more remaining candidates with a minimum value of the total rank are added to the set of candidates (operation 410). For example, each remaining candidate's numeric ranks from the three rankings are summed into the total rank, and one or more candidates with the lowest total rank are added to the set of candidates to optimize across all of the objectives.

Operations 406-410 may be repeated while candidates continue to be added to the set (operation 412). For example, rankings of remaining candidates may be updated to reflect newly added candidates to the set (operation 406), total ranks of the remaining candidates are recalculated based on the updated rankings (operation 408), and one or more remaining candidates with the resulting minimum total rank are added to the set of candidates (operation 410) while the counts of attributes are not covered by the set of candidates and/or other constraints associated with the objectives are not met.

Operations 404-412 may further be repeated for additional individual candidates (operation 414) identified in operation 402. As a result, the number of sets of candidates generated for the set of opportunities equals the number of individual candidates that maximize the coverage of the counts of attributes required by the opportunities.

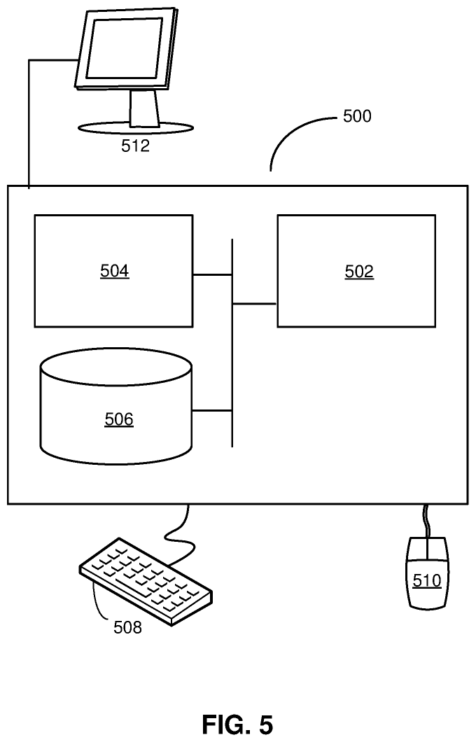

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the disclosed embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes a selection apparatus, a ranking apparatus, and a search apparatus, one or more of which may alternatively be termed or implemented as a module, mechanism, or other type of system component. The selection apparatus obtains, based on parameters of a search of an online system by a user, counts of attributes required by a set of opportunities within a team. Next, the selection apparatus determines, based on data retrieved from a data store, multiple sets of candidates for the set of opportunities based on multiple objectives that comprise maximizing coverage of the counts of attributes by a given set of candidates. The ranking apparatus then selects, from the multiple sets of candidates, one or more sets of candidates that best meet one or more combinations of the multiple objectives. Finally, the search apparatus outputs, in a user interface of the online system, the one or more sets of candidates as recommendations for filling the set of opportunities in the team.

In addition, one or more components of computer system 400 may be remotely located and connected to the other components over a network. Portions of the present embodiments (e.g., selection apparatus, scoring apparatus, search apparatus, data repository, online network, etc.) may also be located on different nodes of a distributed system that implements the embodiments. For example, the present embodiments may be implemented using a cloud computing system that generates search results containing multiple sets of candidates for searches performed by a set of remote recruiting entities and/or users.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining, based on parameters of a search of an online system by a user, counts of attributes required by a set of opportunities within a team;
determining, by one or more computer systems based on data retrieved from a data store, multiple sets of candidates for the set of opportunities based on multiple objectives that comprise maximizing coverage of the counts of attributes by a given set of candidates;
selecting, by the one or more computer systems from the multiple sets of candidates, one or more sets of candidates that best meet one or more combinations of the multiple objectives; and
outputting, in a user interface of the online system, the one or more sets of candidates as recommendations for filling the set of opportunities in the team.

2. The method of claim 1, wherein determining the multiple sets of candidates for the set of opportunities based on the multiple objectives comprises:
identifying, from a pool of candidates, individual candidates that maximize coverage of the counts of attributes required by the set of opportunities; and
initializing the multiple set of candidates as one-element sets comprising the individual candidates.

3. The method of claim 2, wherein determining the multiple sets of candidates for the set of opportunities based on the multiple objectives further comprises:
for each set of candidates in the multiple sets of candidates, determining rankings of remaining candidates from the pool of candidates that are not in the set of candidates based on values associated with the multiple objectives between the remaining candidates and the set of candidates;
for each candidate in the remaining candidates, combining numeric ranks of the candidate in the rankings into a total rank of the candidate across the rankings; and
adding one or more of the remaining candidates with a minimum value of the total rank to the set of candidates.

4. The method of claim 3, wherein determining the multiple sets of candidates for the set of opportunities based on the multiple objectives further comprises:
for each set of candidates in the multiple sets of candidates, updating the rankings of the remaining candidates by the multiple objectives to reflect the one or more of the remaining candidates added to the set of candidates; and
for each candidate in the remaining candidates, recalculating the total rank of the candidate across the updated rankings.

5. The method of claim 3, wherein determining the rankings of the remaining candidates by the multiple objectives comprises:
generating a ranking of the remaining candidates by a skew from a distribution of one or more attributes in the pool of candidates.

6. The method of claim 3, wherein determining the rankings of the remaining candidates by the multiple objectives comprises:
generating a ranking of the remaining candidates by an average connectivity with the set of candidates.

7. The method of claim 3, wherein determining the rankings of the remaining candidates by the multiple objectives comprises:
generating a ranking of the remaining candidates by coverage of the counts of attributes required by the set of opportunities.

8. The method of claim 3, wherein combining the numeric ranks of the candidate in the rankings into a total rank of the candidate across the rankings comprises:
summing the numeric ranks of the candidate in the rankings into the total rank for the candidate.

9. The method of claim 1, wherein selecting the one or more sets of candidates that best meet the one or more combinations of the multiple objectives comprises:
determining an aggregate ranking of the multiple sets of candidates by the multiple objectives; and
including at least a portion of the aggregate ranking in the selected one or more sets of candidates.

10. The method of claim 9, wherein determining the aggregate ranking of the multiple set of candidates by the multiple objectives comprises:
generating rankings of the multiple sets of candidates by the multiple objectives;
for each set of candidates in the multiple sets of candidates, summing numeric ranks of the set of candidates in the rankings into a team rank for the set of candidates; and
ordering the multiple sets of candidates by the team rank in the aggregate ranking.

11. The method of claim 1, wherein selecting the one or more sets of candidates that best meet the one or more combinations of the multiple objectives comprises:
removing duplicate sets of candidates from the multiple sets of candidates; and
selecting the one or more sets of candidates with a smallest number of candidates from the multiple sets of candidates.

12. The method of claim 1, wherein the attributes comprise a set of skills.

13. A system, comprising:
one or more processors; and
memory storing instructions that, when executed by the one or more processors, cause the system to:
obtain, based on parameters of a search of an online system by a user, counts of attributes required by a set of opportunities within a team;
determine, based on data retrieved from a data store, multiple sets of candidates for the set of opportunities based on multiple objectives that comprise maximizing coverage of the counts of attributes by a given set of candidates;
select, from the multiple sets of candidates, one or more sets of candidates that best meet one or more combinations of the multiple objectives; and
output, in a user interface of the online system, the one or more sets of candidates as recommendations for filling the set of opportunities in the team.

14. The system of claim 13, wherein determining the multiple sets of candidates for the set of opportunities based on the multiple objectives comprises:
identifying, from a pool of candidates, individual candidates that maximize coverage of the counts of attributes required by the set of opportunities; and
initializing the multiple set of candidates as one-element sets comprising the individual candidates.

15. The system of claim 14, wherein determining the multiple sets of candidates for the set of opportunities based on the multiple objectives further comprises:
for each set of candidates in the multiple sets of candidates, determining rankings of remaining candidates from the pool of candidates that are not in the set of candidates based on values associated with the multiple objectives between the remaining candidates and the set of candidates;
for each candidate in the remaining candidates, combining numeric ranks of the candidate in the rankings into a total rank of the candidate across the rankings; and
adding one or more of the remaining candidates with a minimum value of the total rank to the set of candidates.

16. The system of claim 15, wherein determining the multiple sets of candidates for the set of opportunities based on the multiple objectives further comprises:
for each set of candidates in the multiple sets of candidates, updating the rankings of the remaining candidates by the multiple objectives to reflect the one or more of the remaining candidates added to the set of candidates; and
for each candidate in the remaining candidates, recalculating the total rank of the candidate across the updated rankings.

17. The system of claim 14, wherein determining the rankings of the remaining candidates by the multiple objectives comprises:
generating a first ranking of the remaining candidates by a skew from a distribution of one or more attributes in the pool of candidates;
generating a second ranking of the remaining candidates by an average connectivity with the set of candidates; and
generating a third ranking of the remaining candidates by coverage of the counts of attributes required by the set of opportunities.

18. The system of claim 13, wherein selecting the one or more sets of candidates that best meet the one or more combinations of the multiple objectives comprises:
generating rankings of the multiple sets of candidates by the multiple objectives;
for each set of candidates in the multiple sets of candidates, summing numeric ranks of the set of candidates in the rankings into a team rank for the set of candidates;
ordering the multiple sets of candidates by the team rank in an aggregate ranking; and
including at least a portion of the aggregate ranking in the selected one or more sets of candidates.

19. The system of claim 13, wherein selecting the one or more sets of candidates that best meet the one or more combinations of the multiple objectives comprises:
removing duplicate sets of candidates from the multiple sets of candidates; and
selecting the one or more sets of candidates with a smallest number of candidates from the multiple sets of candidates.

20. A non-transitory computer-readable storage medium storing instructions that when executed by a computer cause the computer to perform a method, the method comprising:
obtaining, based on parameters of a search of an online system by a user, counts of attributes required by a set of opportunities within a team;
determining, based on data retrieved from a data store, multiple sets of candidates for the set of opportunities based on multiple objectives that comprise maximizing coverage of the counts of attributes by a given set of candidates;
selecting, from the multiple sets of candidates, one or more sets of candidates that best meet one or more combinations of the multiple objectives; and
outputting, in a user interface of the online system, the one or more sets of candidates as recommendations for filling the set of opportunities in the team.
